(19) United States
(12) Patent Application Publication
(10) Pub. No.: US 2004/0139298 A1
(43) Pub. Date: Jul. 15, 2004

(54) Method and apparatus for instruction compression and decompression in a cache memory

(75) Inventors: Lane Thomas Holloway, Pflugerville, TX (US); Nadeem Malik, Austin, TX (US); Avijit Saha, Somers, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/339,763

(22) Filed: Jan. 9, 2003

(51) Int. Cl. G06F 9/30

(52) U.S. Cl. 712/210

(57) ABSTRACT

A method, apparatus, and computer instructions for processing a set of instructions in which the set of instructions includes operation codes and operands. A repeating sequence of sequential operation codes within the set of instructions is identified to form an identified sequence of operation codes. The set of instructions is compressed using the identified sequence of operation codes to form a set of compressed instructions for execution by a processor.

### BACKGROUND OF THE INVENTION

1. Technical Field

The present invention relates generally to an improved data processing system and in particular to an improved method and apparatus for processing data. Still more particularly, the present invention provides a method and apparatus for compressing and decompressing instructions.

2. Description of Related Art

Many data processing systems contain reduced instruction set computer (RISC) processors. This type of computer architecture reduces chip complexity by using simpler instructions. Compilers generate software routines to perform complex instructions that were previously performed by hardware. RISC type processors inherently suffer from low code density. Many attempts have been made to increase the code density for RISC processors by applying compression to linear code segments. These attempts include using a dictionary approach for compressing an instruction. This type of approach, however, does not provide optimum compression because the nature of the instructions for RISC processors is such that while the first half of instructions correspond to a small set of operation codes, also referred to as “op codes”, the second half of the instruction can be any number of register or data operands. An instruction for this type of architecture includes an operation code and an operand. The operation code is the part of the machine instruction that tells the computer what to do, such as input, add, or branch. The operand is the part of the machine instruction that references data or a peripheral device. The operation code functions as a verb while the operands function as nouns on which the actions are taken. This type of instruction makes the possible set of operation code and operand combination very large. As a result, the available repetition at the instruction level is low.

Therefore, it would be advantageous to have an improved method, apparatus, and computer instructions for compressing and decompressing instructions for a processor.

### SUMMARY OF THE INVENTION

The present invention provides a method, apparatus, and computer instructions for processing a set of instructions in which the set of instructions includes operation codes and operands. A repeating sequence of sequential operation codes within the set of instructions is identified to form an identified sequence of operation codes. The set of instructions is compressed using the identified sequence of operation codes to form a set of compressed instructions for execution by a processor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram illustrating components used in compressing and decompressing instructions for a processor in accordance with a preferred embodiment of the present invention;

FIGS. 4A-4C are diagrams illustrating a compression process in accordance with a preferred embodiment of the present invention;

FIGS. 5A-SC re diagrams illustrating the compression process in accordance with a preferred embodiment of the present invention;

FIG. 6 is a flowchart of a process for compressing code using a static dictionary in accordance with a preferred embodiment of the present invention;

FIG. 7 is a flowchart of a process for compressing code using a dynamic dictionary in accordance with a preferred embodiment of the present invention; and

FIG. 8 is a flowchart of a process for processing instructions transferred from a cache to a processor in accordance with a preferred embodiment of the present invention.

### DETAILED DESCRIPTION OF THE PREFERRED EMBODIMENT

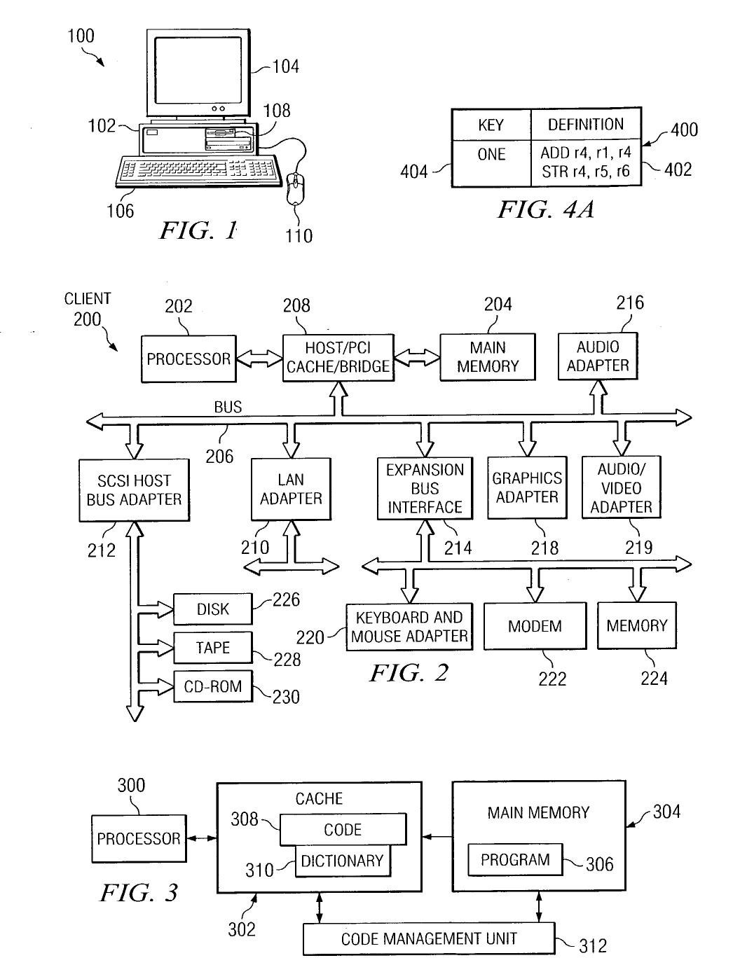

With reference now to the figures and in particular with reference to FIG. 1, a pictorial representation of a data processing system in which the present invention may be implemented is depicted in accordance with a preferred embodiment of the present invention. A computer, computer 100, is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may he used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230.

An operating system runs on processor 202 and is used to coordinate and provide control of various components within data processing system 200 in FIG. 2. The operating system may be a commercially available operating system such as AIX, which is available from International Business Machines Corporation. Instructions for the operating system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM drive 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides an improved method, apparatus, and computer instructions for compressing and decompressing instructions for processors, such as RISC processors. In addition to RISC processor architectures, the present invention may be applied to other processor architectures, such as complex instruction set computer (CISC) based processors. The mechanism of the present invention recognizes that many instructions and programs appear in pairs. By recognizing this fact, the mechanism of the present invention increases compression by compressing operation code fields and operand fields separately across sequential instructions in a program. This type of compression increases code density of programs with very little increase in overhead. Further, with this increase in code density, the chance of a cache hit is increased because more data may be placed into a cache block in compressed form. By increasing cache hits, less time is spent by the processor waiting for information to appear in the cache and subsequently, in the processor.

Turning now to FIG. 3, a block diagram illustrating components used in compressing and decompressing instructions for a processor is depicted in accordance with a preferred embodiment of the present invention. In this example, processor 300, cache 302, and main memory 304 are components that may be found in a data processing system, such as data processing system 200 in FIG. 2. Program 306 in main memory 304 contains instructions to be executed by processor 300. Code 308 is a subset of instructions from program 306 stored within cache 302 to reduce the time needed to obtain instructions for processing by processor 300. Further, in this example, dictionary 310 is also located in cache 302 and provides a data structure used for compressing and decompressing instructions within code 308. The process of compressing and decompressing instructions is performed by code management unit 312 in these examples. The code management unit is a software component in this illustration.

In these examples, code management unit 312 performs compression processes on program 306 in main memory 304. The instructions in program 306 are analyzed with repeating sequences of sequential instructions being identified. These repeating sequences may be instructions or in a preferred embodiment of the present invention, the repeating sequence is identified based on repeating sequences of sequential operation codes or operands in the instructions.

After program 306 is compressed, then portions of program 306 are transferred to cache 302 to form code 308. If a cache hit occurs, the instruction in code 308 is examined to determine whether the instruction is compressed. If the particular instruction is compressed, decompression is performed by code management unit 312 with the decompressed instruction then being sent to processor 300 for execution. Dictionary 310 is used to perform the decompression of code 308. In this example, dictionary 310 is located in cache 302. Of course, depending on the particular implementation, dictionary 310 may be located in other locations, such as main memory 304.

Dictionary 310 may take the form of a static dictionary or a dynamic dictionary depending on the particular implementation. If dictionary 310 takes the form of a static dictionary, then only instructions within program 306 that match entries within dictionary 310 are compressed. In the case that dictionary 310 is dynamic, the dictionary is generated as program 306 is analyzed and compressed by code management unit 312. In this case, entries are created each time a sequential number of instructions are identified as repeating within program 306. In both a dynamic dictionary and a static dictionary, the entry includes the instruction or the portion of the instruction identified as being repeating as well as a code or key that is to be used to replace the repeating operand or operation code.

In these examples, the compression may occur by identifying sequential operands or operation codes that occur in pairs. Of course, other numbers of operands or operation codes may be identified for compression. For example, the sequential set of operands may take the form of three or four operands, rather than two. Then, any other repeating sequences of the sequential instructions are used to compress the instructions in program 306.

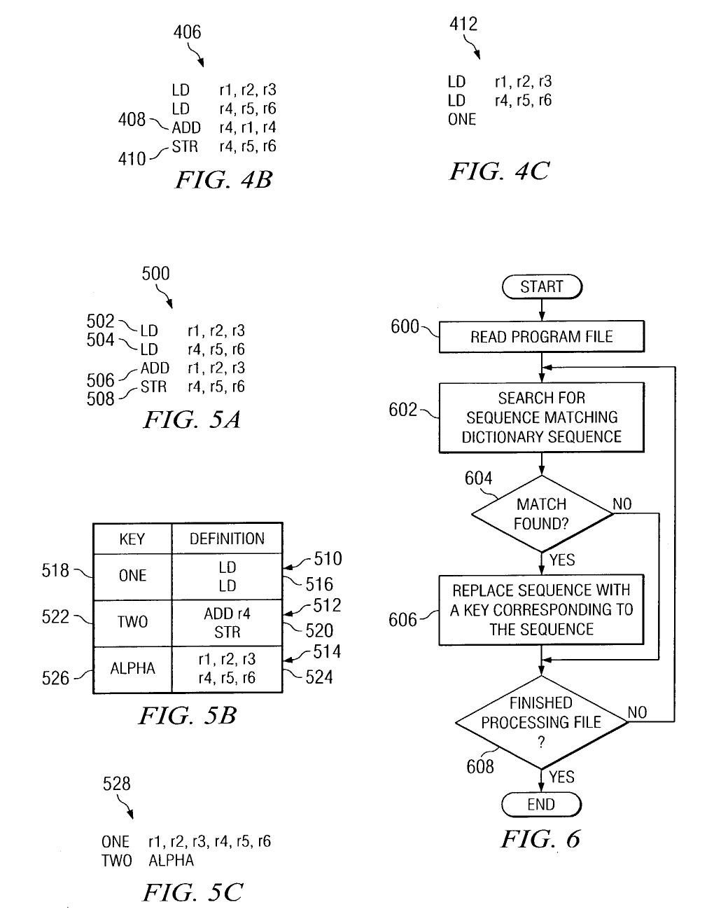

Turning now to FIGS. 4A-4C, diagrams illustrating a compression process are depicted in accordance with a preferred embodiment of the present invention. In this example, the compression process is performed using a static dictionary containing entries, such as entry 400 in FIG. 4A. The compression performed in these examples may be performed using a compression/decompression unit, such as code management unit 312 in FIG. 3.

In this example, entry 400 includes definition 402 and key 404. Code 406 in FIG. 4B is an illustration of uncompressed code from a program, which may be compressed using a static dictionary. This dictionary may be, for example, dictionary 310 in FIG. 3. In this example, the instruction in lines 408 and 410 correspond to definition 402 in entry 400. As a result, a code management unit compresses code 406 in FIG. 4B to form code 412 in FIG. 4C. As can be seen, in this case two lines of code are compressed into a single key, providing memory savings for storage that may be limited in size, such as a cache for a processor.

Turning now to FIGS. 5A-5C, diagrams illustrating the compression process are depicted in accordance with a preferred embodiment of the present invention. In this example, the compression process is employed using a dynamic dictionary. The compression performed in these examples may be performed using a compression/decompression unit, such as code management unit 312 in FIG. 3.

In this example, code 500 is a portion of a program in which the operation codes in lines 502 and 504 are identified as sequential operation codes that are repeated elsewhere within the program. The operation codes in lines 506 and 508 also are identified as being sequential instructions that are repeated elsewhere in the program. Additionally, the operands in lines 506 and 508 are located in sequential instructions that repeat elsewhere in the program code.

As a result of these identifications, a code management unit generates a dictionary containing entries 510, 512, and 514 as depicted in FIG. 5B. In this case, definition 516 and entry 510 contain the operation codes from the instructions on lines 502 and 504 with a key 518 being assigned to entry 510. In entry 512, the operation codes from lines 506 and 508 form definition 520 with key 522 being assigned to entry 512. The operands from instructions 506 and 508 are used to form definition 524 in entry 514 with key 526 being assigned to entry 514. With these entries, code 500 is compressed to form code 528 in FIG. 5C.

As can be seen in this example, operation codes and operands are processed separately as part of the compression process. This bifurcation of the operation codes and operands is used because the present invention recognizes that often operation codes may be identified as repeating elsewhere in the program, while instances in which the entire instruction, including both the operation code and the operands, occur less often. The entire program is compressed using entries generated from the identification of sequential instructions that repeat within the program. By sequentially repeating two or more sequential instructions, such as the add and store instructions found in line 506 and 508 in FIG. 5A may be found again elsewhere in the program. Of course, these examples show the use of pairs of sequential instructions. The sequential instructions may take the form of other numbers other than pairs. For example, three or four sequential instructions may be identified as repeating and used for compression.

Turning now to FIG. 6, a flowchart of a process for compressing code using a static dictionary is depicted in accordance with a preferred embodiment of the present invention. The process illustrated in FIG. 6 may be implemented in a decompression/compression process, such as code management unit 312 in FIG. 3.

The processing begins by reading the program file (step 600). Thereafter, a search for a sequence of instructions matching the dictionary sequence is performed on the program (step 602). A determination is then made as to whether a match has been found (step 604). If a match has been found, then the sequence is replaced with a key corresponding to the sequence in the dictionary (step 606). A determination is then made as to whether processing of the file has completed (step 608). In step 608, the processing completes if all of the definitions in the dictionary have been searched for in the program. If the processing has finished, the process terminates. Otherwise, the process returns to step 602 to continue searching using another definition in the dictionary.

Returning again to step 604, is a match is not found, the process proceeds to step 608 as described above.

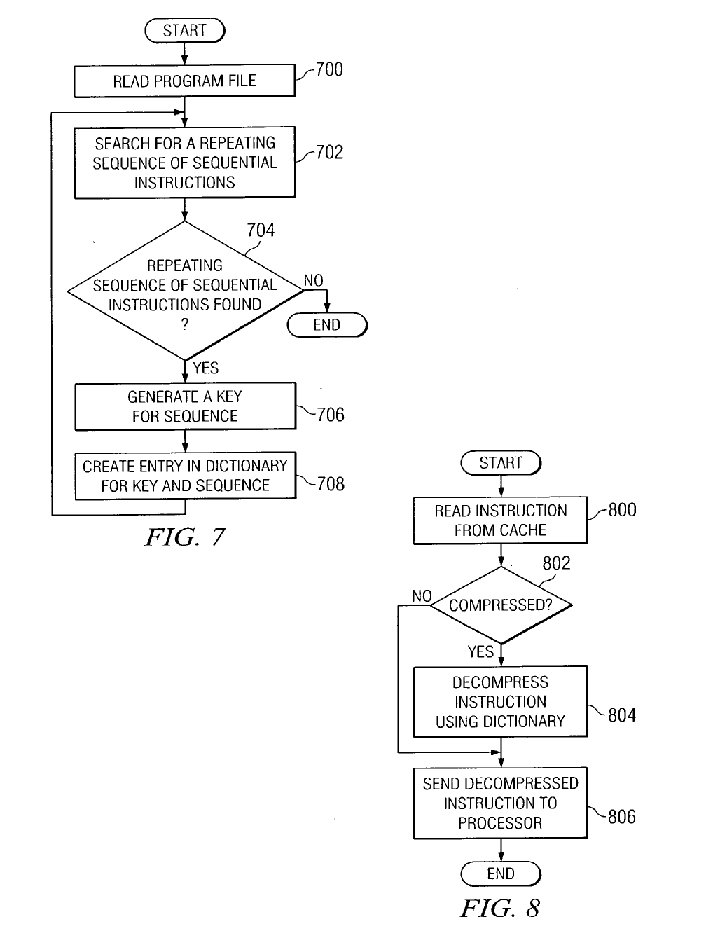

With reference next to FIG. 7, a flowchart of a process for compressing code using a dynamic dictionary is depicted in accordance with a preferred embodiment of the present invention. The process illustrated in FIG. 6 may be implemented using a decompression/compression process, such as code management unit 312 in FIG. 3

The process begins by reading the program file (step 700). Thereafter, a search is performed for a repeating sequence of sequential instructions (step 702). A determination is then made as to whether a repeating sequence of sequential instructions was found (step 704). If a repeating sequence of sequential instructions is found, a key is generated for this sequence (step 706). Thereafter, an entry is created in a dictionary for the key and sequence (step 708) with the process then returning to step 702 as described above. With reference again to step 704, if a repeating sequence of sequential instructions is not found in the program file then the process terminates.

Turning now to FIG. 8, a flowchart of a process for processing instructions transferred from a cache to a processor is depicted in accordance with a preferred embodiment of the present invention. The process illustrated in FIG. 8 may be implemented in a decompression/compression process, such as code management unit 312 in FIG. 3.

The process begins by reading an instruction from the cache matching a cache hit (step 800). A determination is then made as to whether the instruction is compressed (step 802). This determination is made by comparing the instruction with entries in the dictionary. If a key in the dictionary matches the instruction, then the instruction is identified as being compressed. Depending on the particular implementation, the comparison may be made for both the operand and the operation code portion of the instruction.

If the instruction is identified as being compressed, the instruction is decompressed using the dictionary (step 804). The decompression in step 804 occurs by replacing the key or instruction obtained from the cache with the definition in the dictionary. Thereafter, the decompressed instruction is sent to the processor (step 806) with the process terminating thereafter.

With reference again to step 802, if the instruction is not identified as being compressed, the process proceeds to step 806 as described above.

Thus, the present invention provides an improvee method, apparatus, and computer instructions for compressing and decompressing instructions. The mechanism of the present invention identifies sequential instructions in a program that are repeated within the program. These sequential instructions are replaced with a key. In the depicted examples, either a static or a dynamic dictionary may be employed for this process. Further, instruction may be bifurcated in the compression by processing the operation code and the operand separately. The mechanism of the present invention increases the code density through this type of compression. In this manner, more data may be placed into a cache block in compressed form, increasing the likelihood of a cache hit. With this increased likelihood of a cache hit, less time is spent by a processor waiting on information to appear in the cache.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a set of instructions, wherein the set of instructions includes operation codes and operands, the method comprising:
identifying a repeating sequence of sequential operation codes within the set of instructions to form an identified sequence of operation codes; and
compressing the set of instructions using the identified sequence of operation codes to form a set of compressed instructions for execution by a processor.

2. The method of claim 1 further comprising:
identifying a repeating sequence of operation codes within the set of instructions to form an identified sequence of operands; and
compressing the instructions using the identified sequence of operation codes.

3. The method of claim 1 further comprising:
generating a dictionary for use in decompressing the set of instructions.

4. The method of claim 3, wherein the set of compressed instructions and the dictionary are stored in a cache associated with the processor.

5. The method of claim 3, wherein the dictionary is generated prior to identifying the repeating sequence of sequential operation codes and is used in identifying the repeating sequence of sequential operation codes.

6. The method of claim 3, wherein entries in the dictionary are dynamically generated in response to identifying repeating sequences of sequential operation codes.

7. The method of claim 1 further comprising:
executing the set of compressed instructions by the processor; and
decompressing a compressed instruction for execution when the compressed instruction is encountered during execution of the set of compressed instructions.

8. The method of claim 1, wherein the identified sequence of operation codes is a pair of operation codes.

9. The method of claim 1 further comprising:
identifying a repeating sequence of operands within the set of instructions to form an identified sequence of operands; and
compressing the set of instructions using the identified sequence of operands to form the set of compressed instructions for execution by the processor.

10. The method of claim 1, wherein a portion of the set of compressed instructions are loaded in a cache associated with the processor and further comprising:
responsive to identifying an instruction within the set of compressed instructions that is to be sent to the processor for execution, determining whether the instruction is a compressed instruction;
responsive to the instruction being a compressed instruction, decompressing the instruction to form a decompressed instruction; and
sending the decompressed instruction to the processor for execution.

11. A data processing system for processing a set of instructions, wherein the set of instructions includes operation codes and operands, the data processing system comprising:
a bus system;
a communications unit connected to the bus system;
a memory connected to the bus system, wherein the memory includes a set of instructions; and
a processing unit connected to the bus system, wherein the processing unit executes the set of instructions to identify a repeating sequence of sequential operation codes within the set of instructions to form an identified sequence of operation codes; and compress the set of instructions using the identified sequence of operation codes to form a set of compressed instructions for execution by a processor.

12. A data processing system for processing a set of instructions, wherein the set of instructions includes operation codes and operands, the data processing system comprising:
identifying means for identifying a repeating sequence of sequential operation codes within the set of instructions to form an identified sequence of operation codes; and
compressing means for compressing the set of instructions using the identified sequence of operation codes to form a set of compressed instructions for execution by a processor.

13. The data processing system of claim 12, wherein the identifying means is a first identifying means and the compressing means is a first compressing means and further comprising:
second identifying means for identifying a repeating sequence of operation codes within the set of instructions to form an identified sequence of operands; and
second compressing means for compressing the instructions using the identified sequence of operation codes.

14. The data processing system of claim 12 further comprising:
generating means for generating a dictionary for use in decompressing the set of instructions.

15. The data processing system of claim 14, wherein the set of compressed instructions and the dictionary are stored in a cache associated with the processor.

16. The data processing system of claim 14, wherein the dictionary is generated prior to identifying the repeating sequence of sequential operation codes and is used in identifying the repeating sequence of sequential operation codes.

17. The data processing system of claim 14, wherein entries in the dictionary are dynamically generated in response to identifying repeating sequences of sequential operation codes.

18. The data processing system of claim 12, further comprising:
executing means for executing the set of compressed instructions by the processor; and
decompressing means for decompressing a compressed instruction for execution when the compressed instruction is encountered during execution of the set of compressed instructions.

19. The data processing system of claim 12, wherein the identified sequence of operation codes is a pair of operation codes.

20. The data processing system of claim 12, wherein the identifying means is a first identifying means and the compressing means is a first compressing means and further comprising:
second identifying means for identifying a repeating sequence of operands within the set of instructions to form an identified sequence of operands; and
second compressing means for compressing the set of instructions using the identified sequence of operands to form the set of compressed instructions for execution by the processor.

21. The data processing system of claim 12, wherein a portion of the set of compressed instructions are loaded in a cache associated with the processor and further comprising:
determining means, responsive to identifying an instruction within the set of compressed instructions that is to be sent to the processor for execution, for determining whether the instruction is a compressed instruction;
decompressing means, responsive to the instruction being a compressed instruction, for decompressing the instruction to form a decompressed instruction; and
sending means for sending the decompressed instruction to the processor for execution.

22. A computer program product for processing a set of instructions, wherein the set of instructions includes operation codes and operands, the computer program product comprising:
first instructions for identifying a repeating sequence of sequential operation codes within the set of instructions to form an identified sequence of operation codes; and
second instructions for compressing the set of instructions using the identified sequence of operation codes to form a set of compressed instructions for execution by a processor.
